(19) United States
(12) Patent Application Publication
(10) Pub. No.: US 2025/0121292 A1
(43) Pub. Date: Apr. 17, 2025

(54) VIRTUAL AND AUGMENTED REALITY FITNESS TRAINING ACTIVITY OR GAMES, SYSTEMS, METHODS, AND DEVICES

(71) Applicant: Meta Platforms Technologies, LLC, Menlo Park, CA (US)

(72) Inventors: Aaron KOBLIN, Los Angeles, CA (US); Chris MILK, Redding, CT (US); Phillip WILLIAMS, Camas, WA (US); Scott SULLIVAN, San Francisco, CA (US)

(73) Assignee: Meta Platforms Technologies, LLC, Menlo Park, CA (US)

(21) Appl. No.: 18/702,214

(22) PCT Filed: Oct. 17, 2022
(86) PCT No.: PCT/US2022/046894

§ 371 Date: Apr. 17, 2024

Related U.S. Application Data
(60) Provisional application No. 63/257,146, filed on Oct. 19, 2021.

(51) Int. Cl. A63F 13/80; A63F 13/212; A63F 13/213; A63F 13/65; G02B 27/01

(52) U.S. Cl. CPC A63F 13/80; A63F 13/212; A63F 13/213; A63F 13/65; G02B 27/0101; A63F 2300/8082; G02B 2027/014

(57) ABSTRACT

A computer-implemented method conveys information within a virtual environment to a person wearing a virtual reality (VR) headset in a real-world environment. The method includes determining a visual routine for the person to view in the virtual world, the routine comprising a series of images, including triangles, wherein a triangle has a defined perimeter and apex, the visual routine lasting a predetermined time. Presenting, based on the determining, a first triangle to the person in the virtual world; and generating a virtual graphical mark at a prescribed location about the defined perimeter of the first triangle within the virtual world, the virtual graphical mark on the defined perimeter being visible to the person, a relative position of the virtual graphical mark with respect to the apex conveying information relating to an aspect of the visual routine.

### RELATED APPLICATIONS

This application claims the benefit of U.S. provisional patent application No. 63/257,146, filed Oct. 19, 2021, the entire contents of which are hereby fully incorporated herein by reference for all purposes.

### FIELD OF THE INVENTION

This invention relates generally to Virtual Reality (VR), Mixed Reality (MR), and Augmented Reality (AR), hereinafter collectively referred to as “XR,” and, more particularly, to methods, systems, and devices supporting gaming, entertainment, exercise, and training in a VR environment.

### BACKGROUND

XR devices allow a user to view and interact with virtual and augmented environments. A user may effectively immerse themselves in a created digital environment and interact with that environment. For example, a user may interact (e.g., play a game) in a virtual environment, where the user's real-world movements are translated to movements and actions in the virtual world. Thus, e.g., a user may simulate a game of tennis or fencing or the like in a virtual environment by their real-world movements.

People should get regular exercise, and many attend group or individual exercise programs at gyms, schools, or the like. During these programs, users are instructed and guided through exercise routines, usually by a person (e.g., a coach) who can monitor, instruct, and encourage participants. A good coach or instructor may customize a routine for a user and may modify the routine based on that user's performance. However, in some situations (e.g., during quarantine for a pandemic), users may not be able or willing to attend such programs outside the comfort of their homes.

It is desirable, and an object of this invention, to provide instruction and guided personalized exercise routines.

It is a further object of this invention to provide various features to the game that provide new challenges and interest to the player during gameplay.

### SUMMARY

The present invention is specified in the claims as well as in the below description. Preferred embodiments are particularly specified in the dependent claims and the description of various embodiments.

A system of one or more computers can be configured to perform particular operations or actions by virtue of having software, firmware, hardware, or a combination of them installed on the system that, in operation, causes the system to perform the actions. One or more computer programs can be configured to perform particular operations or actions by virtue of including instructions that, when executed by data processing apparatus, cause the apparatus to perform the actions.

One general aspect includes a method for determining if a certain level of gameplay performance of a player has been reached while using a computer system to play a game within a virtual reality environment. The player wears a headset having a display for viewing the VR environment and an object-tracking system. The object tracking system of the headset is capable of tracking movement of a portion of the player in 3-D space to establish an actual-response path by the player during gameplay. The method comprises a) calculating, at a first time, an ideal-response path of gameplay for the tracked portion of the player in 3-D space to follow in order for the player to achieve a certain level of gameplay performance. The method further comprises b) comparing, at a second time, the actual-response path with the calculated ideal-response path, and c) indicating, in response to a match in the comparing step, that the certain level of gameplay performance has been reached by the player.

Another general aspect includes a computer-implemented method for conveying information to a person within a virtual environment. The computer-implemented method also includes the person using a device in a real-world environment, where the device may include a virtual reality (VR) headset being worn by the person, the VR headset being capable of providing images of scenes and objects to the person through the VR headset to generate a visual representation of a virtual world. The method may include: (a) determining a visual routine for the person to view in the virtual world using the VR headset, the visual routine may include a series of images representing projectiles, including triangles, where a triangle has a shape with a defined perimeter and an apex, the visual routine lasting a predetermined period of time. The method may also include (b) presenting, based on the determining in (a), a first triangle to the person in the virtual world. The method may further include (c) generating a virtual graphical mark at a prescribed location about the defined perimeter of the first triangle within the virtual world, the virtual graphical mark on the defined perimeter being visible to the person, a relative position of the virtual graphical mark with respect to the apex conveying information relating to an aspect of the visual routine.

Other exemplary embodiments of this aspect include corresponding computer systems, apparatus, and computer programs recorded on one or more computer storage devices, each configured to perform the actions of the methods.
Implementations may include one or more of the following features, alone and/or in combination(s):
The method where the virtual graphic mark may include a gap within the defined perimeter of the first triangle.
The method where the aspect of the visual routine includes timing information related to the predetermined period of time.
The method where the aspect of the visual routine includes a number of projectiles.

Another general aspect includes a computer-implemented method where a person uses a device in a real-world environment, where the device may include a virtual reality (VR) headset and at least one handheld controller, being worn by the person, the VR headset being capable of providing images of scenes and objects to the person through the VR headset to generate a visual representation of a virtual world, the handheld controller being able to translate a real-hand location of the person's hand in the real world to a corresponding VR-hand location in the virtual world. The method may also include (a) providing a graphically generated and dynamically located handheld implement at the VR-hand location in the virtual world, where the handheld implement is viewable in the VR/virtual world based on the person's real-hand location in the real world. The method may also include (b) determining a visual routine for the person to view in the virtual world using the VR headset, the visual routine may include at least one target projected towards the person in the virtual world, the at least one target being generated at a graphically generated portal within the virtual world at a portal location in front of the person in the virtual world, the at least one target being designed to be hit by the handheld implement in the virtual world when the target is located near the person in the virtual world. The method may also include (c) projecting, based on the determining in (b), at least one target towards the person in the virtual world. The method may also include (d) changing at least one aspect of the at least one target before the target reaches the person in the virtual world. Other exemplary embodiments of this aspect include corresponding computer systems, apparatus, and computer programs recorded on one or more computer storage devices, each configured to perform the actions of the methods.

Implementations may include one or more of the following features, alone and/or in combination(s):
The method where the changing in (d) includes splitting the target into two.
The method where the changing in (d) includes graphically changing the target to appear transparent to the person.
The method where the changing in (d) includes graphically changing the target to appear to be between 5% and 50% opaque to the person.
The method where the changing in (d) includes changing a projection speed of the target as it approaches the person.

Another general aspect includes a computer-implemented method where a person uses a device in a real-world environment, where the device may include a virtual reality (VR) headset and at least one handheld controller, being worn by the person, the VR headset being capable of providing images of scenes and objects to the person through the VR headset to generate a visual representation of a virtual world, the handheld controller being able to translate a real-hand location of the person's hand in the real world to a corresponding VR-hand location in the virtual world. The method may include (a) providing a graphically generated and dynamically located handheld implement at the VR-hand location in the virtual world, so that the handheld implement is viewable in the virtual world based on the person's real-hand location in the real world. The method may also include (b) determining a visual routine for the person to view in the virtual world using the VR headset, the visual routine may include at least one target projected towards the person in the virtual world, the at least one target being generated at a graphically generated portal within the virtual world at a portal location in front of the person, the at least one target being designed to be hit by the handheld implement in the virtual world when the target is located near the person in the virtual world. The method may also include (c) projecting, based on the determining in (b), at least one target towards the person in the virtual world. The method may also include (d) changing at least one aspect of the handheld implement before the at least one target reaches the person in the virtual world. Other exemplary embodiments of this aspect include corresponding computer systems, apparatus, and computer programs recorded on one or more computer storage devices, each configured to perform the actions of the methods.

Implementations may include one or more of the following features, alone and/or in combination(s):
The method where the handheld implements are elongated members.
The method where the changing step includes changing a color of the handheld implement.
The method where the changing step includes changing a length of the handheld implement.

Implementations of the described techniques may include hardware, a method or process, or computer software on a computer-accessible medium.

Below is a list of process (method) embodiments. Those will be indicated with the letter “P.” Whenever such embodiments are referred to, this will be done by referring to “P” embodiments.
P1. A computer-implemented method for conveying information to a person within a virtual environment,
the person using a device in a real-world environment, wherein the device comprises a virtual reality (VR) headset being worn by the person, the VR headset being capable of providing images of scenes and objects to the person through the VR headset to generate a visual representation of a virtual world;
the method comprising:
(A) determining a visual routine for the person to view in the virtual world using the VR headset, the visual routine comprising a series of images representing projectiles, including triangles, wherein a triangle has a shape with a defined perimeter and an apex, the visual routine lasting a predetermined period of time;
(B) presenting, based on the determining in (A), a first triangle to the person in the virtual world; and
(C) generating a virtual graphical mark at a prescribed location about the defined perimeter of the first triangle within the virtual world, the virtual graphical mark on the defined perimeter being visible to the person, a relative position of the virtual graphical mark with respect to the apex conveying information relating to an aspect of the visual routine.
P2. The computer-implemented method of any of the method embodiments, wherein the virtual graphic mark comprises a gap within the defined perimeter of the first triangle.
P3. The computer-implemented method of any of the method embodiments, wherein the aspect of the visual routine includes timing information related to the predetermined period of time.
P4. The computer-implemented method of any of the method embodiments, wherein the aspect of the visual routine includes a number of projectiles.
P5. A computer-implemented method,
wherein a person uses a device in a real-world environment, wherein the device comprises a virtual reality (VR) headset and at least one handheld controller, being worn by the person, the VR headset being capable of providing images of scenes and objects to the person through the VR headset to generate a visual representation of a virtual world, the handheld controller being able to translate a real-hand location of the person's hand in the real world to a corresponding VR-hand location in the virtual world;
the method comprising:
(A) providing a graphically generated and dynamically located handheld implement at the VR-hand location in the virtual world, wherein the handheld implement is viewable in the virtual world based on the person's real-hand location in the real world;
(B) determining a visual routine for the person to view in the virtual world using the VR headset, the visual routine comprising at least one target projected towards the person in the virtual world, the at least one target being generating at a graphically generated portal within the virtual world at a portal location in front of the person in the virtual world, the at least one target being designed to be hit by the handheld implement in the virtual world when the target is located near the person in the virtual world;
(C) projecting, based on the determining in (B), at least one target towards the person in the virtual world; and
(D) changing at least one aspect of the at least one target before the target reaches the person in the virtual world.
P6. The computer-implemented method of any of the method embodiments, wherein the changing in (D) includes splitting the target into two.
P7. The computer-implemented method of any of the method embodiments, wherein the changing in (D) includes graphically changing the target to appear transparent to the person.
P8. The computer-implemented method of any of the method embodiments, wherein the changing in (D) includes graphically changing the target to appear to be between 5% and 50% opaque to the person.
P9. The computer-implemented method of any of the method embodiments, wherein the changing in (D) includes changing a projection speed of the target as it approaches the person.
P10. A computer-implemented method, comprising:
wherein a person uses a device in a real-world environment, wherein the device comprises a virtual reality (VR) headset and at least one handheld controller, being worn by the person, the VR headset being capable of providing images of scenes and objects to the person through the VR headset to generate a visual representation of a virtual world, the handheld controller being able to translate a real-hand location of the person's hand in the real world to a corresponding VR-hand location in the virtual world,
the method comprising:
(A) providing a graphically generated and dynamically located handheld implement at the VR-hand location in the virtual world, so that the handheld implement is viewable in the virtual world based on the person's real-hand location in the real world;
(B) determining a visual routine for the person to view in the virtual world using the VR headset, the visual routine comprising at least one target projected towards the person in the virtual world, the at least one target being generating at a graphically generated portal within the virtual world at a portal location in front of the person, the at least one target being designed to be hit by the handheld implement in the virtual world when the target is located near the person in the virtual world;
(C) projecting, based on the determining in (B), at least one target towards the person in the virtual world; and
(D) changing at least one aspect of the handheld implement before the at least one target reaches the person in the virtual world.
P11. The computer-implemented method of any of the method embodiments, wherein the handheld implements are elongated members.
P12. The computer-implemented method of any of the method embodiments, wherein changing includes changing a color of the handheld implement.
P13. The computer-implemented method of any of the method embodiments, wherein changing includes changing a length of the handheld implement.

Below are device embodiments, indicated with the letter “D.”
D14. A device comprising:
(a) hardware, including memory and at least one processor, and
(b) a service running on the hardware, wherein the service is configured to perform the method of any of the preceding method embodiments P1-P13.

Below is an article of manufacture embodiment, indicated with the letter “M.”
M15. An article of manufacture comprising non-transitory computer-readable media having computer-readable instructions stored thereon, the computer-readable instructions including instructions for implementing a computer-implemented method, the method operable on a device comprising hardware including memory and at least one processor and running a service on the hardware, the method comprising the method of any one of the preceding method embodiments P1-P13.

Below are computer-readable recording medium embodiment, indicated with the letter “R.”
R16. A non-transitory computer-readable recording medium storing one or more programs, which, when executed, cause one or more processors to, at least: perform the method of any one of the preceding method embodiments P1-P13.

The above features, along with additional details of the invention, are described further in the examples herein, which are intended to further illustrate the invention but are not intended to limit its scope in any way.

### BRIEF DESCRIPTION OF THE DRAWINGS

Objects, features, and characteristics of the present invention, as well as the methods of operation and functions of the related elements of structure, and the combination of parts and economies of manufacture, will become more apparent upon consideration of the following description and the appended claims with reference to the accompanying drawings, all of which form a part of this specification.

FIG. 1 depicts aspects of a virtual reality personalized and customized exercise and training system according to exemplary embodiments hereof;

FIG. 2 depicts aspects of an exercise and training system according to exemplary embodiments hereof;

FIG. 3 depicts aspects of a mapping and transforming telemetry data according to exemplary embodiments hereof;

FIG. 4 depicts aspects of exemplary data structures for a training system according to exemplary embodiments hereof;

FIGS. 5A to 5M depict exemplary objects for a training system according to exemplary embodiments hereof;

FIGS. 6A to 6H depict aspects of the virtual reality personalized and customized training system according to exemplary embodiments hereof;

FIGS. 7-8 are screenshots or images of aspects of an implementation, according to exemplary embodiments hereof;

FIGS. 9a-9b depicts a triangle having aspects to convey information, according to exemplary embodiments hereof;

FIGS. 10a-10b depicts a triangle having breakaway segments, according to exemplary embodiments hereof;

FIGS. 11a-11b depicts aspects of batons that can change size, according to exemplary embodiments hereof;

FIG. 12 depicts aspects of a hit object that may selectively break apart or become less opaque, according to exemplary embodiments hereof;

FIG. 13 depicts aspects of a hit object that may convey graphic information during gameplay, according to exemplary embodiments hereof;

FIG. 14 depicts aspects of a hit object according to exemplary embodiments hereof; and

FIG. 15 is a logical block diagram depicting aspects of a computer system.

### DETAILED DESCRIPTION OF THE PREFERRED EXEMPLARY EMBODIMENTS

### a) Glossary and Abbreviations

As used herein, unless used otherwise, the following terms or abbreviations have the following meanings:
Augmented Reality (AR) refers to or means an interactive experience of a real-world environment where select objects that reside in the real world are enhanced by computer-generated perceptual information, often across multiple sensory modalities, such as visual, auditory, and haptic.
Virtual Reality (VR) refers to or means an interactive experience wherein a person interacts within a computer-generated, three-dimensional environment, a “virtual world,” using electronic devices, such as hand-held controllers.
Mixed Reality (MR) refers to or means an interactive system that uses both virtual reality and augmented reality technologies to create an environment where physical and virtual objects can exist and interact in real time.
XR is a term used herein which refers to the three current forms of altered reality, Virtual Reality (VR), Mixed Reality (MR), and Augmented Reality (AR).

### b) Description

In the following, exemplary embodiments of the invention will be described, referring to the figures. These examples are provided to provide further understanding of the invention, without limiting its scope. The exemplary embodiments described herein are described as being applied to virtual reality, including the use of a VR headset being worn by a VR player, which displays a VR game having a VR environment within a VR display. It is to be understood that the present technology, as described, may equally be applied to all XR devices, without departing from the gist of the invention and that the application towards VR devices is just exemplary.

In the following description, a series of features and/or steps are described. The skilled person will appreciate that unless required by the context, the order of features and steps is not critical for the resulting configuration and its effect. Further, it will be apparent to the skilled person that irrespective of the order of features and steps, the presence or absence of time delay between steps, can be present between some or all of the described steps.

It will be appreciated that variations to the foregoing embodiments of the invention can be made while still falling within the scope of the invention. Alternative features serving the same, equivalent, or similar purpose can replace features disclosed in the specification, unless stated otherwise. Thus, unless stated otherwise, each feature disclosed represents one example of a generic series of equivalent or similar features.

Although the term “game” is used throughout this description, the present technology can be applied to a variety of electronic devices and immersive experiences, including, but not limited to, games, educational interactions, such as online teaching of math or languages, fitness-related activities using electronic devices, such as the below-described fitness program, called “Supernatural,” for use with a virtual reality headset, and even business activities. For reasons of simplicity and clarity, all the applications of the present technology are referred to as “games” and “gaming” in this application.

With the development of virtual reality (VR) and with recent improvements of accurate inertial sensors, high resolution displays, and specifically-developed 3-D software, playing a VR game can become a truly immersive and often emotional experience. The hardware requirements to achieve a truly immersive, interactive and realistic gaming experience lends itself perfectly to providing valuable biometric and accurate body movement information, in real time, without adding additional sensors.

For example, a popular VR system called the Quest 2, designed and manufactured by Oculus, a brand of Facebook Technologies, Inc., located in Menlo Park, California, includes a VR headset and two handheld wireless controllers. This VR headset includes forward-facing cameras, a gyroscope and accelerometer (also called an IMU or Inertial Measurement Unit), and an array of infrared LEDs and an IMU located within each hand controller. These sensors are very accurate and provide precise orientation and position information of both the headset and each controller, in 3-D space, essentially in real time (updated 1,000 times per second) during gameplay. Game developers of VR games use this information to effectively establish the location and orientation of the player's head, their hands and fingers in real time during a game. Software developers create virtual handheld objects, such as tennis rackets or batons, which appear in the VR/virtual world, e.g., as seen by the player, through the VR headset (and, with remote displays connected, may also appear for others not wearing the VR headset to view). The virtual handheld objects are directly controlled by the player's hand movements in the real world. Therefore, the location, orientation, speed and direction of movement of the virtual handheld objects, in real time, are known as well.

The use of a VR system allows a player's senses to become truly isolated from the surrounding real-world environment. By wearing a typical VR headset, the player can only view the images that are presented by the VR system, similar to the focus an audience gains when watching a movie in a dark movie theater. The VR headset effectively provides a 3-Dimensional movie theater experience. The VR system also provides sound input for the player's ears, thereby further enhancing the sense that the experience is real. By controlling both visual and auditory inputs to a player, and effectively separating the player from real-world sensory inputs (i.e., real-world distractions), VR games offer a player a greater chance to focus, improve gaming performance, and, depending on the type of VR software being played, even provide an effective workout.

To help explain this inventive technology, a representative fitness game is illustrated in the accompanying figures. It should be noted that the present technology is meant to be applied to a specific type of 3-D virtual reality game that uses projectiles and geometric shapes, projected at a player, to encourage the user to move various muscle groups for the purpose of both entertainment and exercise. One exemplary such game of which the presently described embodiments could be applied is a virtual reality fitness game called “Supernatural.” It was developed by, and is currently available from, a company called Within, Inc., located in Los Angeles, California.

In this particular exemplary game, a player dons a suitable virtual reality headset and hand controllers, such as the above-identified Quest 2, by Facebook's Oculus brand. Once the Supernatural game begins, a three-dimensional environment image, such as a mountain setting, is automatically generated and displayed within the player's headset, placing the player at a center point within this computer-generated virtual environment, as is well known by those of ordinary skill in the art of VR technology. The player will experience this virtual environment as a realistic three-dimensional image, one that can be viewed in all directions, as if the player were standing in the same environment in the real world. As the player moves their head left and right, up and down, the above-described sensors located within the VR headset will detect this head movement in extremely fine resolution. The running software program (e.g., Supernatural) will collect and analyze this sensor data to adjust the displayed environment image in real time (effectively immediately) to match the exact minute increments of head movement and also the direction and speed of the player's head to accurately create an illusion of presence, within the environment. The illusion is sufficient to convince the player that they are truly part of the virtual world being displayed, literally right in front of the player's eyes.

Continuing with this example, in the fitness game called Supernatural, the player is meant to remain at a substantially fixed location in the real world during gameplay so that their VR presence remains at a central point within the VR environment.

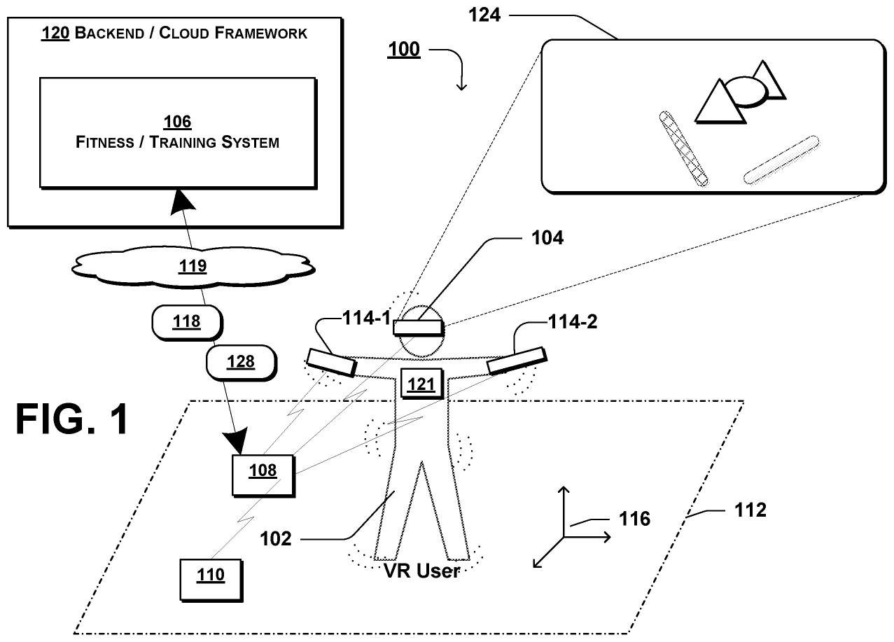

A system supporting a real-time virtual reality (VR) environment 100 for a virtual and augmented reality fitness training system is described now with reference to FIG. 1, in which a person (VR user) 102 in a real-world environment or space 112 uses a VR device or headset 104 to view and interact with and within a virtual environment. The VR headset 104 may be connected (wired and/or wirelessly) to a training system 106, e.g., via an access point 108 (e.g., a Wi-Fi access point or the like). Since the user's activity may include a lot of movement, the VR headset 104 is preferably wirelessly connected to the access point 108. In some cases, the VR headset 104 may connect to the training system 106 via a user device or computer system (not shown). While shown as a separate component, in some embodiments, the access point 108 may be incorporated into the VR headset 104.

Sensors (not shown in the drawings) in the VR headset 104 and/or other sensors 110 in the user's environment may track the VR user's actual movements (e.g., head movements, etc.) and other information. The VR headset 104 preferably provides user tracking without external sensors. In a presently preferred implementation, the VR headset 104 is an Oculus Quest headset made by Facebook Technologies, LLC.

Tracking or telemetry data from the VR headset 104 may be provided in real-time (as all or part of data 118) to the training system 106.

Similarly, data from the sensor(s) 110 may also be provided to the training system 106 (e.g., via the access point 108).

The user 102 preferably has one or two handheld devices 114-1, 114-2 (collectively handheld device(s) and/or controller(s) 114) (e.g., Oculus Touch Controllers). Hand movement information and/or control information from the handheld controller(s) 114 may be provided with the data 118 to the training system 106 (e.g., via the access point 108).

In some embodiments, hand movement information and/or control information from the handheld controller(s) 114 may be provided to the VR headset 104 or to another computing device which may then provide that information to the training system 106. In such cases, the handheld controller(s) 114 may communicate wirelessly with the VR headset 104.

In some embodiments, at least some of a user's hand movement information may be determined by tracking one or both of the user's hands (e.g., if the user does not have a handheld controller 114 on/in one or both of their hands, then the controller-free hand(s) may be tracked directly, e.g., using 3D tracking).

Although described here as using one or two handheld controllers 114, those of skill in the art will understand, upon reading this description, that a user may have no handheld controllers or may have only one. Furthermore, even when a user has a handheld controller in/on their hand, that hand may also (or instead) be tracked directly.

The VR headset 104 presents the VR user 102 with a view 124 corresponding to that VR user's virtual or augmented environment.

Preferably, the view 124 of the VR user's virtual environment is shown as if seen from the location, perspective, and orientation of the VR user 102. The VR user's view 124 may be provided as a VR view or as an augmented view (e.g., an AR view).

In some embodiments, the user 102 may perform an activity such as an exercise routine or a game or the like in the VR user's virtual environment. The training system 106 may provide exercise routine information to the VR headset 104. In presently preferred embodiments, the activity system 126 may provide a so-called beat-map and/or other information 128 to the headset (e.g., via the network 119 and the access point 108).

As the user progresses through an activity such as an exercise routine, the VR headset 104 may store information about the position and orientation of the VR headset 104 and of the controllers 114 for the user's left and right hands.

In a present implementation, the user's activity (and a beat-map) is divided into sections (e.g., 20-second sections), and the information is collected and stored at a high frequency (e.g., 72 Hz) within a section. The VR headset 104 may also store information about the location of targets, portals and all objects that are temporally variant, where they are in the 3-D space, whether any have been hit, etc., at the same or similar frequency. This collected information allows the fitness system to evaluate and/or recreate a scene at any moment in time in the space of that section.

Collected information may then be sent to the training system 106, preferably in real-time, as all or part of data 118, as the user's activity/workout continues, and several of these sections may be sent to the training system 106 over the course of an activity/workout. The data 118 that are provided to the training system 106 preferably include beat-map information.

The training system 106 may be part of backend/cloud framework 120.

### The Training System

As explained in greater detail below, in some implementations/embodiments, the fitness training system provides a user with an individualized customized VR training routine, tracks the user as they carry out the routine (in VR), modifies the routine if needed, and provides guidance to the user. The routine may involve the user interacting (virtually) with various objects, and the system may monitor and evaluate the user's interactions and movements in order to determine possible modifications to the routine. The system may also use physiological data (e.g., heart rate data) to evaluate a user during a routine.

With reference to FIG. 2, the training system 106 is a computer system (as discussed below), e.g., one or more servers, with processor(s) 202, memory 204, communication mechanisms 206, etc. One or more video fitness/training programs 210 run on the training system 106. The training system 106 may store data in and retrieve data from one or more data structures 224 in memory 204 and/or from one or more databases (not shown). The databases may include a user database to store and maintain information about users of the system.

Although only one user 102 is shown in FIG. 1, it should be appreciated that the video training system 106 may interact with multiple users at the same time. It should also be appreciated that the following description of the operation of the training system 106 with one user extends to multiple users.

The training programs 210 of the training system 106 may include data collection mechanism(s) 212, movement/tracking mechanism(s) 214, mapping and transformation mechanism(s) 216, calibration mechanism(s) 218, routine generation mechanism(s) 220, and routine evaluation mechanism(s) 222.

The data structures 224 may include a routine data structure 226 and a user data structure 228.

In operation, the data collection mechanism(s) 212 obtains data 118 (FIG. 1) from a user (e.g., user 102 in FIG. 1). The data 118 may include at least some of user movement/telemetry data, information about the location of targets, portals and objects that are temporally variant, where they are in space, whether any have been hit, where and how hard they were hit, etc.

The movement/tracking mechanism(s) 214 determines or approximates, from that data, the user's actual movements in the user's real-world space 112. The user's movements may be given relative to a 3-D coordinate system 116 the user's real-world space 112. If the data 118 includes data from the user's handheld controller(s) 114, the movement/tracking mechanism(s) 214 may also determine movement of one or both of the user's hands in the user's real-world space 112. In some cases, the user's headset 104 may provide the user's actual 3-D coordinates in the real-world space 112.

The movement/tracking mechanism(s) 214 may determine or extrapolate aspects of the user's movement based on machine learning (ML) or other models of user movement. For example, a machine learning mechanism may be trained to recognize certain movements and/or types of movements and may then be used to recognize those movements based on the data 118 provided by the user 102.

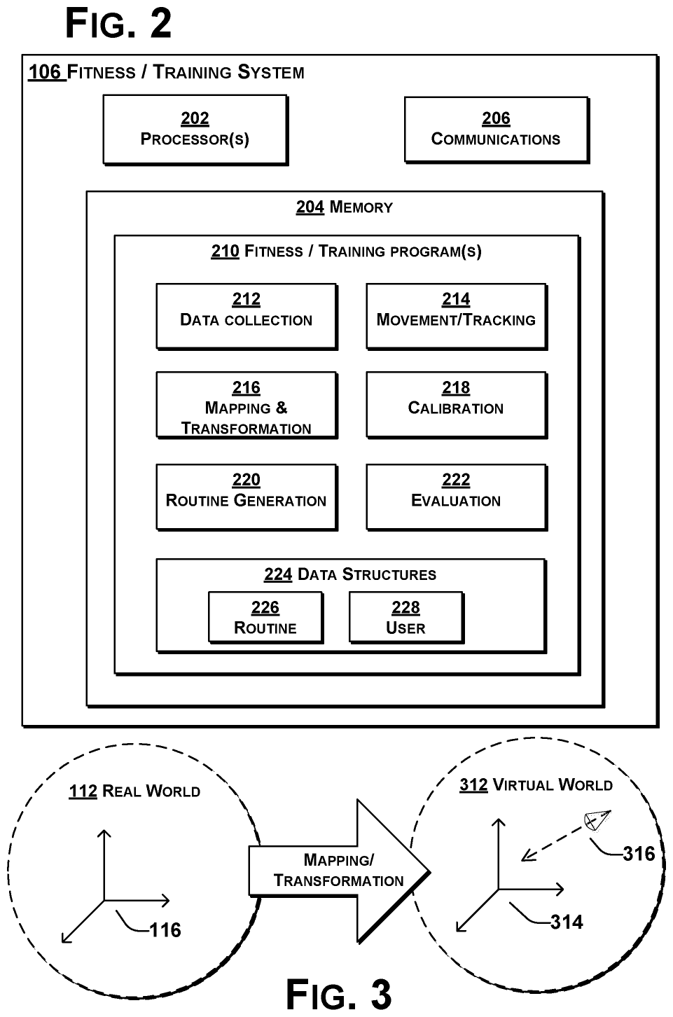

With reference to FIGS. 2 and 3, the mapping and transformation mechanism(s) 216 of FIG. 2 may take the movement/tracking data (as determined by the movement/tracking mechanism(s) 214) and transform those data from the real-world coordinate system 116 in the user's real-world space 112 to corresponding 3-D coordinates in a virtual-world coordinate system 314 in a virtual world 312.

Those of skill in the art will understand, upon reading this description, that the mapping and transformation mechanism(s) 216 may operate prior to or in conjunction with the movement/tracking mechanism(s) 214. As with all mechanisms described herein, the logical boundaries are used to aid the description and are not intended to limit the scope hereof.

For the sake of this description, the user's movement data in the real-world space 112 are referred to as the user's real-world movement data, and the user's movement data in the virtual-world space 312 are referred to as the user's virtual movement data.

In some exemplary embodiments, the training system 106 may also receive or have other user data (e.g., physiological data or the like) and may use some of the physiological data (e.g., heart rate, temperature, sweat level, breathing rate, etc.) to determine or evaluate the user's movements and actions in the virtual space. Such physiological data may be obtained by one or more sensors 121 (FIG. 1) worn by and/or monitoring the user. The sensors 121 may be incorporated into another device such as a watch or the like worn by the user. For example, the sensors 121 may include a heart rate monitor included in an Apple Watch worn by the user.

The training system 106 may be co-located with the user (e.g., in the same room), or it may be fully or wholly located elsewhere. For example, the training system 106 may be located at a location distinct from the user, in which case the user's data 118 may be sent to the training system 106 via a network 119 (e.g., the Internet). Although in preferred cases, the user's data 118 are provided to the training system 106 as the data are generated (i.e., in real time), in some cases, the user's data 118 may be collected and stored at the user's location, and then sent to the training system 106. When located apart from the user, and accessed via a network, the training system 106 may be considered to be a cloud-based system.

### Routines

As noted above, the fitness training system may provide a user with an individualized customized VR training routine. A user's routine may be stored in a routine data structure 226 in the memory 204 of the training system 106.

With reference to FIG. 4, a routine 400 may comprise a time-ordered series of events 402. An event 402 may comprise a source location 404 and an object 406.

An object 406 may comprise a shape 408 and properties 410. Some properties may be shape-specific, as described below.

A shape 408 may be a hit shape 412 (e.g., an orb or circle or the like) or a squat shape 414 (e.g., a symmetric triangle) or a lunge shape 416 (e.g., an oblique or asymmetric triangle).

A lunge shape 416 may have a lunge direction 418 (left or right), and may thus be a left lunge shape or a right lunge shape.

A squat shape 414 or lunge shape 416 may also include a “hold” shape 420, 422, which may include a hold duration (not shown).

The properties 410 of a shape may include its speed 411 (i.e., the speed at which the object or shape approaches the user in VR).

A hit shape (i.e., a target) 412 may include a direction indicator 424, showing the direction in which the shape should be hit. A hit shape 412 may include a color 426 or other indicator showing which hand should be used to hit the shape.

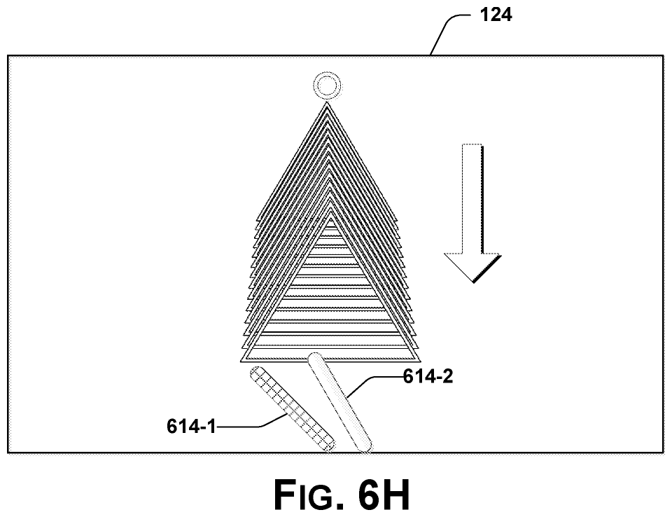

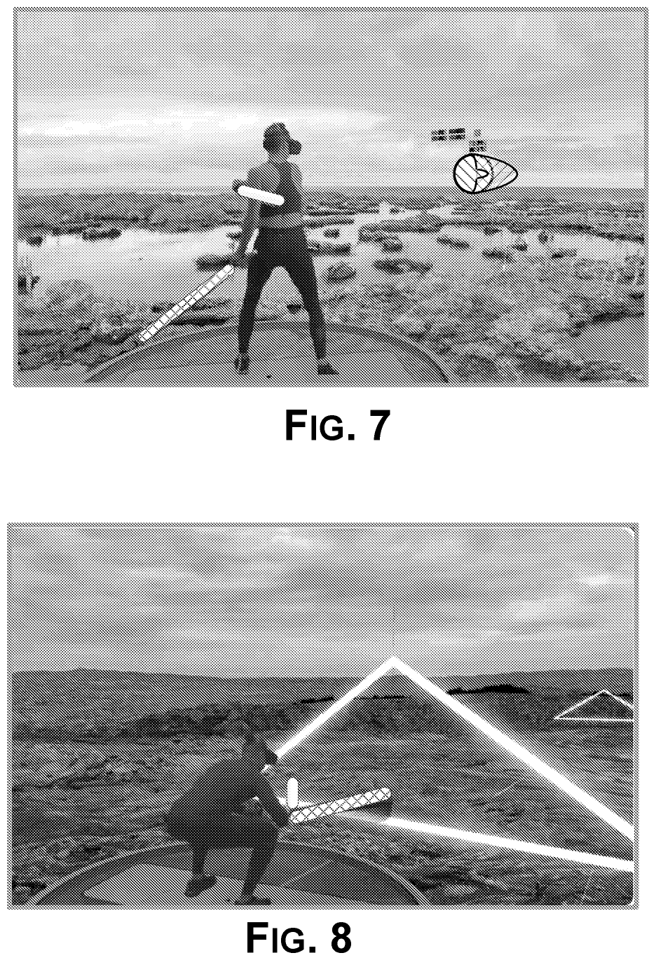

Recall that the user preferably has two controllers 114-1 and 114-2 (see FIG. 1). As shown, e.g., in FIG. 6A, in VR the controllers are represented to the user (on their display 124) as batons or sticks 614-1 and 614-2 or the like in two colors (e.g., black and white). The user should try to hit a hit shape with the controller that matches the color of the shape. Thus, e.g., the user should try to hit black hit shape objects with their black controller and white hit shape objects with their white controller. Although the controllers may be represented to the user as batons or sticks, those of skill in the art will understand, upon reading this description, that any shape or object, real or virtual, may be used to represent the controllers. Furthermore, in cases where the user has one or no controllers, the system may track one or both of the user's hands directly (e.g., in 3D) and may represent the user's hands in VR as hands or as objects such as sticks, batons, etc.

A hit shape 412 may include an arc or tail 428, indicating the type of hit to be used to hit the shape (e.g., a flowing or follow-through hit).

Those of skill in the art will understand, upon reading this description, that different and/or other shapes and/or shape properties may be used.

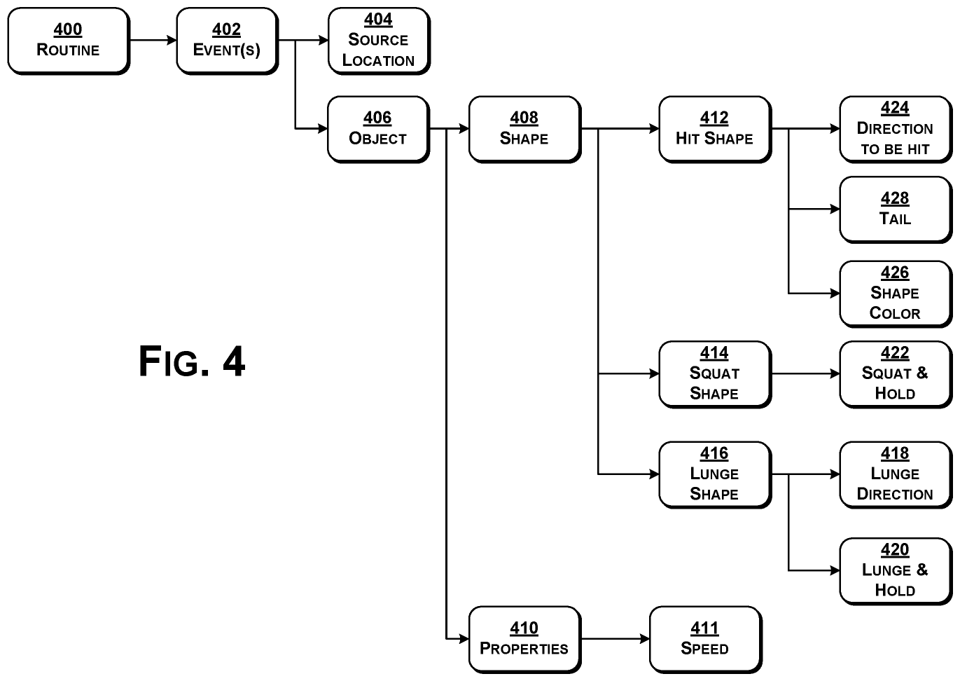

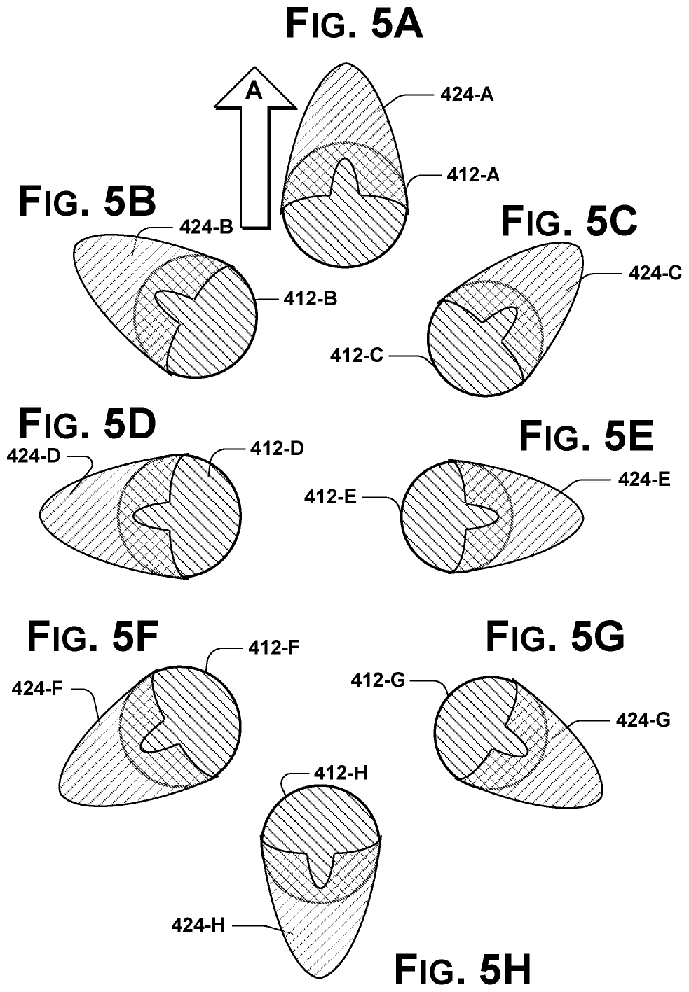

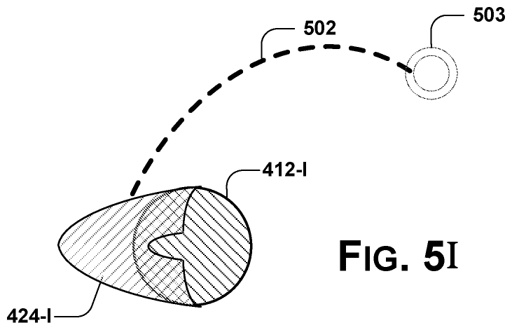

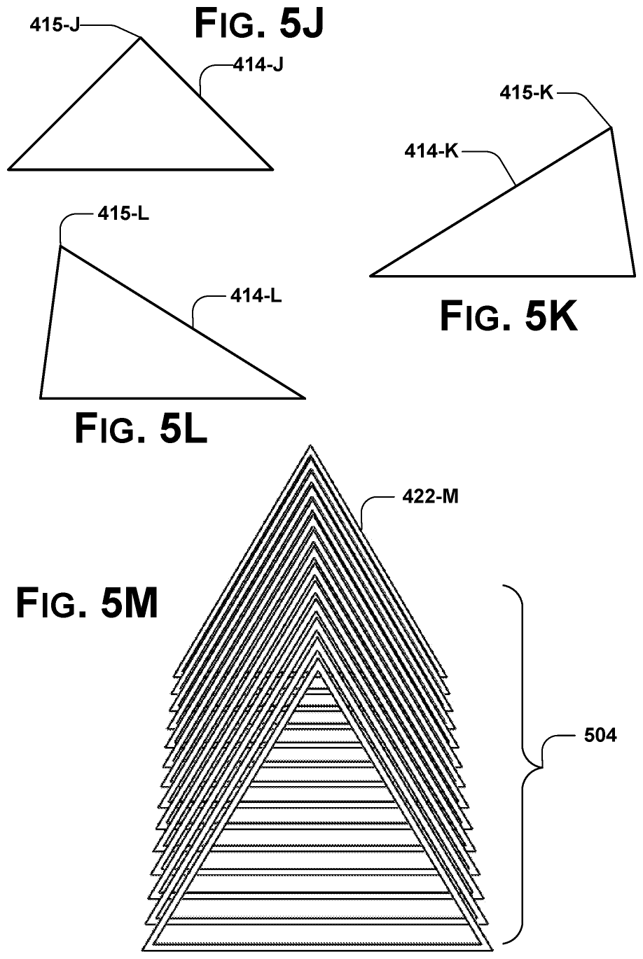

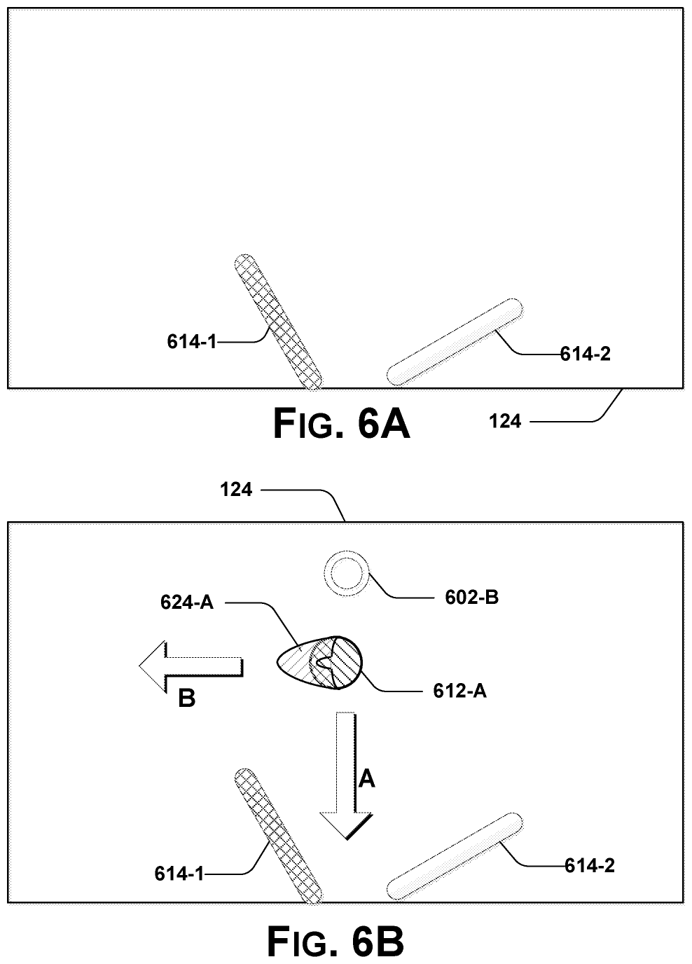

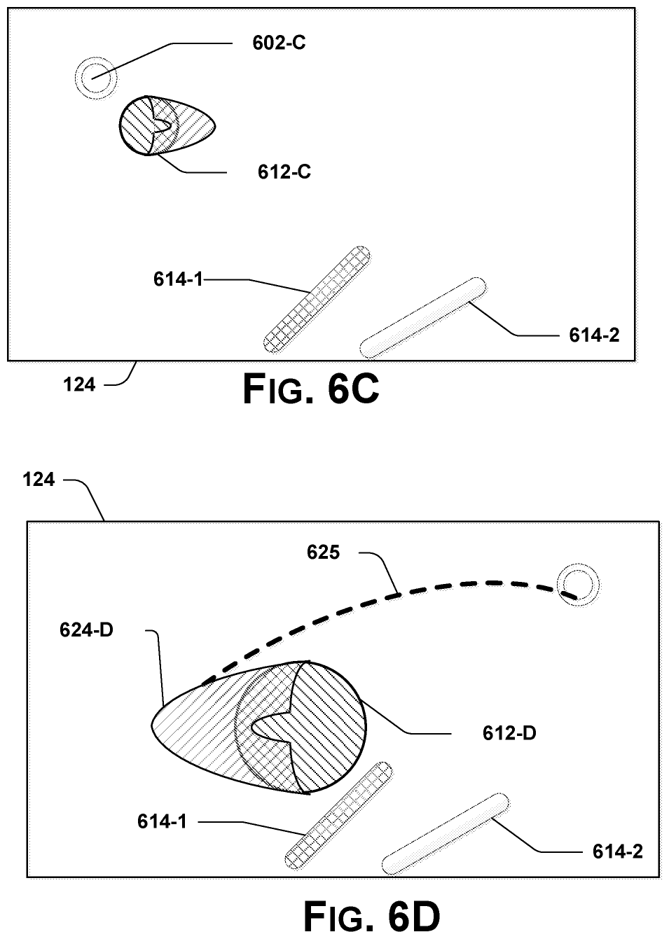

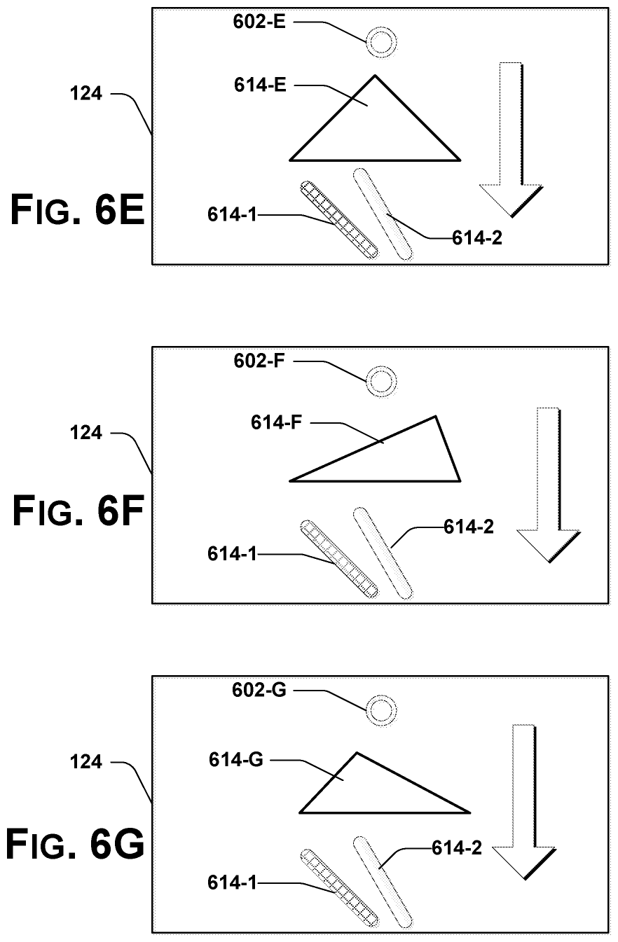

Example hit shapes 412-A-412-H are shown in FIGS. 5A-5H, each showing a corresponding hit direction 424-A-424-H. For example, the hit shape 412-A may comprise an orb with a triangular shaped direction 424-A, indicating that the user should hit the object (the orb) in the direction of the arrow A. Generally, the apex of the triangular direction identifier shows the direction in which the object should be hit.

FIG. 5I shows an example of a hit shape 412-I with corresponding direction indicator 424-I and an arc 502. The arc 502 may extend from the source 503 of the object. When a hit shape has an arc, the user should hit the object in the direction indicated by the object indicator 424-I, and the user should follow through the hit with an arcing motion (instead of just stopping when they contact the object), as indicated by the arc 502.

FIG. 5J shows an exemplary squat shape 414-J. As shown, a squat shape is preferably a symmetric triangle. When a user is presented with a squat shape (i.e., when a squat shape approaches a user in VR), the user should try to squat so that the user's head passes inside the squat shape (e.g., inside the triangle), ideally so that the user's head is positioned immediately adjacent to and directly below the apex of the triangle.

FIGS. 5K and 5L show right and left lunge shapes 416-K, 416-L, respectively. As shown, a lunge shape is preferably an asymmetric triangle, with the shorter side of the triangle indicating the desired lunge direction. When a user is presented with a lunge shape (i.e., when a lunge shape approaches a user in VR), the user should try to lunge in the direction indicated by the lunge shape so that the user's head passes inside the lunge shape (e.g., inside the triangle). So, e.g., for a left lunge shape 416-L, the user should try to lunge to the left and lunge deep or low enough to have their head pass through the lunge shape, again, ideally so that the user's head is positioned immediately adjacent to and directly below the apex of the triangle, regardless of the triangle shape.

FIG. 5M shows an exemplary squat and hold shape, having a squat shape 422--M and a hold portion 504. The squat portion 422--M has the same role as the squat shape 414-J described above. According to another embodiment, hold portion 504 may be represented by a series of repeating triangles, each of whose respective apex may be positioned in the same position as the other adjacent triangles or in different positions. In the latter case, the person will be instructed to squat and lunge in different directions based on the location of the apex of each triangle as each triangle passes by the person. In each case, the person must position their head (VR headset) so that their head in the virtual world passes below and adjacent to each respective apex of each passing triangle.

### EXAMPLES

Various example interactions are shown with reference to FIGS. 6B-6M. These examples are shown from the user's point of view, as presented on the user's display 124. The user is considered to be at the bottom center of the display, with images corresponding to their controllers 614-1 and 614-2 sometimes visible.

In the example in FIG. 6B, the system sends a hit object 612-A towards the user from a portal 602-B, as shown by the arrow A. The portal 602-B is the source of the hit object. The hit object 612-A has a hit direction indicated by the triangular shape 624-A. The hit object 612-A has the same color as the user's left controller 614-1. The user should try to hit the hit object 612-A with their left controller 614-1 in the direction of the arrow B. When the user hits the object (in the VR space), the object will move in the direction it has been hit and/or explode or disintegrate. Various VR effects may be used after an object is hit. If the user misses the object, then the object may appear to move/fly past the user, or bounce to the side.

When a user successfully hits a hit object in the correct direction with the correct controller (baton), the user's hit score may be increased. The user may be given a higher score based on how hard they hit the object.

In the example in FIG. 6C, the system sends a hit object 612-C towards the user from a portal 602-C. The object has the same color as the user's right baton (corresponding to the right controller 614-2), and so the user should try to hit the object 612-C in the direction indicated by the triangular shape 624-C.

Note that in the example in FIG. 6C, the portal 602-C is not in the same location as portal 602-B in FIG. 6B. The portal corresponds to the source of the object, and a particular routine may use multiple portals in multiple distinct locations.

In the example in FIG. 6D, the system sends a hit object 612-D towards the user from a portal 602-D. The hit object 612-D has a tail (or arc) 625-D. To successfully interact with this hit object, the user should try to hit the hit object 612-D with their left baton (based on the matching colors of the object and the baton) in the direction of the triangular shape 624-D.

The tail 625-D indicates that the user should follow through with the hit, preferably with a flowing motion generally following the shape of the particular tail. FIG. 7 shows an example of a player preparing to hit a hit object during gameplay.

In the example in FIG. 6E, the system sends a squat shape 614-E towards the user from a portal 602-E. In response, the user should try to squat into the object so that the user appears to pass through the object in VR space. By determining, e.g., the height and position of the user's head, the system can determine how well they squatted, and the system may adjust their squat score(s) accordingly. FIG. 8 shows an example of a user squatting to pass through a squat object during gameplay.

In the example in FIG. 6F, the system sends a right lunge shape 614-F towards the user from a portal 602-F. In response, the user should try to lunge to the right so that the user appears to pass through the shape 614-F in VR space. By determining, e.g., the height and position of the user's head, the system can determine how well they lunged, and the system may adjust their lunge score accordingly. Similarly, in the example in FIG. 6G, the system sends a left lunge shape 614-G towards the user from a portal 602-G. In response, the user should try to lunge to the left so that the user appears to pass through the shape 614-G in VR space. By determining, e.g., the height and position of the user's head, the system can determine how well they lunged, and the system may adjust their lunge score(s) accordingly

In the example in FIG. 6H, the system sends a squat and hold shape 622-H towards the user from a portal 602-H. In response, the user should try to squat into the shape 622-H so that the user appears to pass through the shape 622-H in VR space, and the user should hold the squat until the hold portion 604-H has passed 604-by. By determining, e.g., the height and position of the user's head, the system can determine how well and how long they squatted, and the system may adjust their squat score(s) accordingly.

As should be appreciated, each of the shapes and/or objects discussed in these examples corresponds to an event in a routine. A routine may include multiple events, and a routine may include multiple simultaneous events. For example, a routine may send multiple hit objects to a user at the same time from the same or different sources.

### Conveying Information to the Player Using Virtual Objects and Shapes (E.g., Triangles)

As described above, during gameplay of the present gaming/workout system, hit-objects 412 may project from portal 602 and advance towards player 102, similar to a ball being thrown. As mentioned above, the player holds the baton 114 and uses the same to hit objects when the objects enter a hitting zone, which is adjacent to the player. Each hit-object 412 may include a hit-direction indicator 424 which adds complexity and interest to the game because for the player to receive full credit for a particular hit, the player not only has to hit a passing object, but also hit it in the indicated direction.

Every so often, as a player plays a game session, a lunge triangle 416 will project from portal 602 and advance towards player 102. According to the above-mentioned gameplay rules, in this instance, the player must lunge either left or right, or squat their body down towards the floor in the real world, so that their bodies “fit” within the triangle as the triangle passes the player in the virtual world. In this manner, the shape of the triangle in the virtual world is effectively able to control the shape of the player's body in the real world, at least as the player continues to play the game correctly.

As the game session, or workout is being played, the player can easily become fatigued, both physically and mentally. Applicants contend that it would be desirable for a player to know how long they have been playing a particular game, or workout session, and, perhaps more importantly, how much longer will gameplay or the workout continue before the session ends. Of course, a timer or clock display may be graphically generated within the virtual environment to directly provide this duration information to the player. Unfortunately, providing a simple clock display, even within the field of view of the player, would cause an unwanted diversion from the player's gameplay concentration whenever they just wanted to learn the duration information conveyed by the display. A simple glance at the clock display would require the player to divert their attention from hitting the continuous flow of objects before them, read the time shown on the display, understand its meaning (a diversion within the player's brain), and then quickly return to focus on the objects quickly advancing before them. This entire process may take only a second or two, but that would be long enough to cause a disruption in the player's gameplay focus. The player would likely end up missing at least one or two objects as they passed, and would have to take a few seconds to reorient themselves back to the task of hitting objects, and would likely end up missing a few more passing objects. In this example, learning the time duration of the game would not be worth disrupting the player's flow.

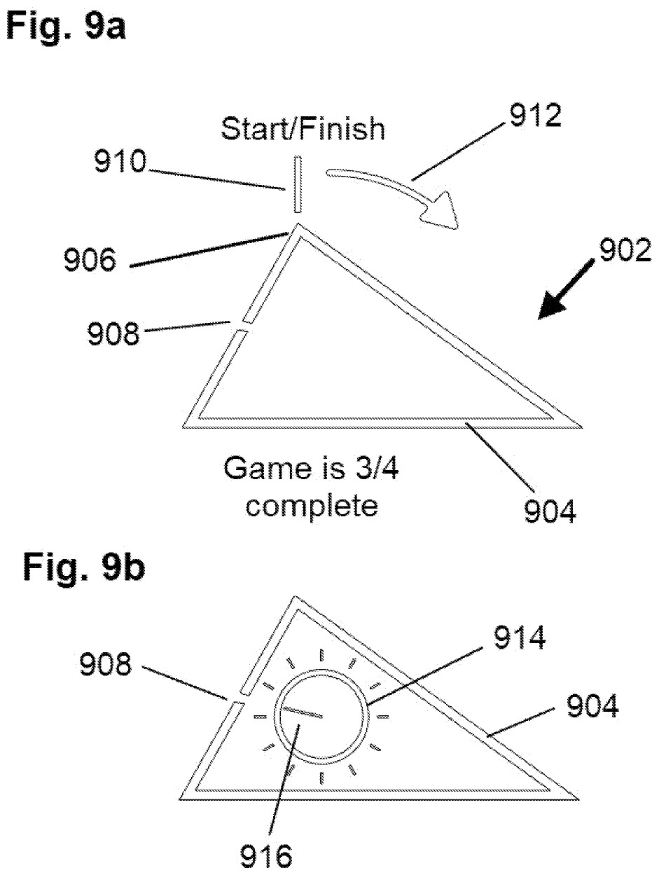

To overcome this deficiency, and according to exemplary embodiments, specific information, such as duration information is displayed, not just in the field of view of the player, but at a known point of focus of the player, as the player plays the game. Some of the known points of focus of a player during gameplay include objects, as they advance, and the lunge and squat triangles. For example, when a triangle advances towards a player, the player will eventually, even if just for a moment, focus on the triangle to understand its shape and the location of its apex, so they can move their body to fit within the triangle as it passes, as the gameplay rules of this particular exemplary workout game require. As shown in FIG. 9a, an exemplary lunge triangle 902 is shown, having a perimeter 904 and an apex 906. A notch or gap 908 is provided in the perimeter 904 of the triangle at a specific location about the perimeter, with respect to apex 906. According to exemplary embodiments, the location of gap 908 about perimeter 904, with respect to apex 906, may be used to convey information to the player. The player is already focused on the approaching triangle and can easily see, either directly or peripherally, the location of gap 908 about the perimeter 904, with respect to the apex of the triangle. Applicants prefer to utilize a conventional analog clock method to graphically convey information, wherein a twelve o'clock position is used to indicate a starting and finishing point 910. Therefore, based on this methodology, the start of a game or workout session, or the total number of objects in a game or workout, or some other “starting” relevant information can be graphically represented by the location of the gap about the triangle's perimeter, with respect to the apex of the triangle. As shown in FIG. 9b, and as an example, early in the game, the player would see notch 908 located at or near the apex or twelve o'clock position of the triangle. As the game advances, the notch would also advance, clockwise (as indicated by arrow 912) around the perimeter 904 of the triangle 902 at a rate that would depend on the information it was conveying. If the notch 908 was conveying the passage of time, then the rate of movement of the notch around the perimeter 904 of the triangle 902 would be either a minute's rate, or a second's rate, respectfully identical to the rate and rotational direction of the minutes and seconds hands moving about an analog clock. FIG. 9b positions a conventional analog clock 914 over a representative exemplary triangle 902 to show that the position of notch 908 matches and is analogous to the position of the hand 916 (either seconds or minutes) of a clock, wherein the apex 906 of the triangle 902 matches the position of the twelve o'clock position of the clock 914.

According to this embodiment, every time a triangle 902 appears in the sequence of projected objects and triangles, and in the user's view, the position of the notch 908 about the perimeter 904 would be updated to a new location.

For example, as mentioned above, the location of the notch 908 could indicate how much game-time has passed, and also how much time is remaining. Applicants prefer that this time-related information is conveyed only graphically and not numerically so that the player does not have to read numbers. This would be similar to how an analog clock does not require numbers, whereas a digital clock does. For an analog clock, the read of the time only has to see the relative locations of the two hands with respect to each other and with respect to the up (or twelve o'clock) position. If the player sees the notch at the bottom of the triangle, then they would understand that the game or workout is halfway complete. Similarly, if the notch is at the nine o'clock position, then the game is three-quarters complete, as illustrated in FIG. 9a. Of course, numbers can be included if desired, but, as mentioned above, providing numbers for the player to read may cause unwanted gameplay distraction.

As mentioned above, the location of notch 908 about triangle 902 may be used to convey other information to a player besides game duration, such as how many of the total number of objects have been hit, or how many objects have so far been projected towards the player, and also how many remain. Conveying this particular information can positively affect a player's motivation and hit efficiency, since if a player understands how much time is remaining, or how many objects have already been hit, they can better plan how to use their remaining strength and mental acuity—similar to how a runner in a race often finds a “second wind” of energy when they learn that they are close to the finish line.

Notch 908 can be graphically represented by the notch cutout, as shown in FIG. 9a and discussed above, or by providing a colorized and contrasting mark along the perimeter 904 of the triangle 902. For example, depending on the color scheme of the virtual environment, perhaps a red mark on a white-colored perimeter would be effective since it could be visually noticeable to a player. Other less contrasting colors for the mark and the perimeter may be used to be less distracting to the player, yet still allow information to be conveyed.

Although other types of information conveyed in this manner could be considered distracting, Applicants further contemplate that numbers and even words can be graphically displayed on the perimeter of the triangles. This may include lyrics to a particular song being played during the game or workout, or immediately relevant coaching advice, such as “Squat lower,” or “Swing the batons harder.” Of course, all this information may be just announced by a gaming voice, over the music being played, but Applicants have determined that providing additional information audibly is also distracting to the player. It must be appreciated that the player is immersed with a graphically intense experience, and conveying information graphically is less distracting, since it appears exactly where a player will be focused at certain times during gameplay.

### Add Hit Segments to the Triangles

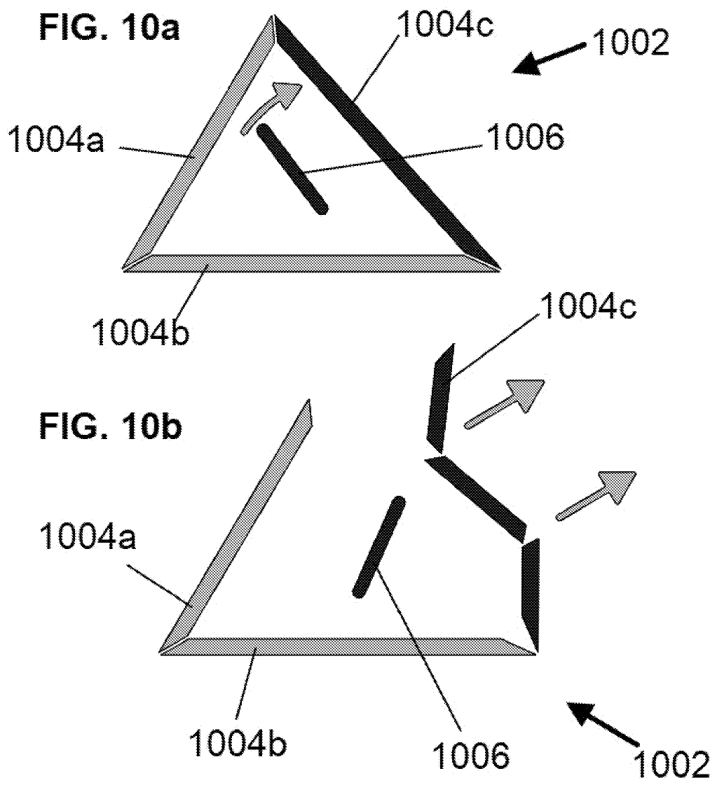

According to another exemplary embodiment, as shown in FIGS. 10a, and 10b, as the player keeps busy striking at the oncoming objects, Applicants propose presenting additional targets during gameplay, as the player is instructed to lunge down or squat down. As a triangle 1002 passes a player, normally, the player understands to squat down or lunge down, either left or right, so that their virtual body fits within the passing triangle. Typically, a player stops swinging their batons as the triangle passes by, since normally the batons are not required during that time. However, according to this exemplary embodiment, triangle 1002 may comprise three connected segments 1004a, 1004b, and 1004c and a select one or more of the three segments 1004a-1004c may become colorized, during gameplay (e.g., matching a color of a baton 1006). Based on this embodiment, the player will be required to hit whichever triangle segment 1004a-1004c becomes colorized with their baton(s) 1006 as the triangle 1002 passes by, or when the triangle 1002 is located just in front of the player. Depending on the desired level of difficulty, the player must either hit the colorized triangle segment with the correct colored baton, or for easier gameplay, just use either baton to hit any of the colorized triangle segments. The segments 1004a-1004c of the triangle 1002 that are meant to be hit will become colorized at some point between a portal (not shown) and the player (not shown). This arrangement adds challenge and complexity to the gameplay experience and forces the player to stay focused, even during the relative calm as a triangle passes by. As should be appreciated, other methods may be used to indicate to the player that a particular segment 1004a-1004c of a select triangle 1002 must be hit, as the triangle 1002 passes, including alternating the illumination or other visual characteristics of the particular segment 1004a-1004c.

### Batons Change Size

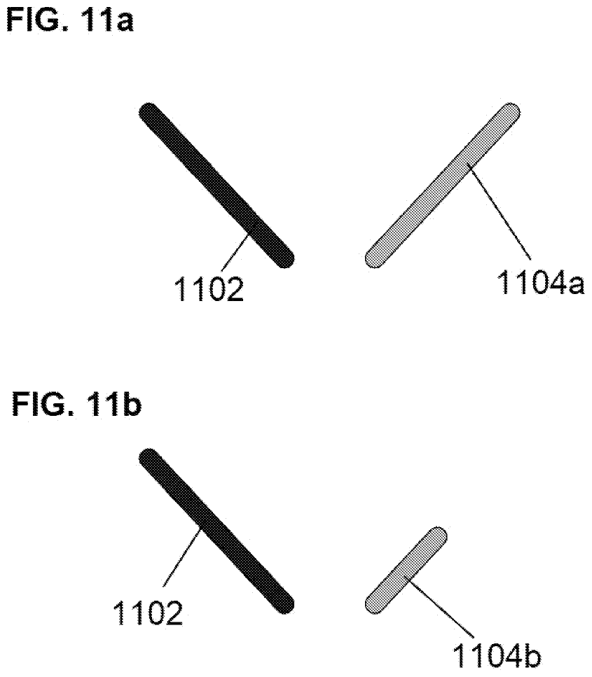

As mentioned above, in this particular VR game, one or more batons may be used by a player to selectively hit fast approaching objects in the directions indicated by their respective hit direction indicators, and according to the color of a particular object being hit. For example, a white colored object must be hit by the white baton, the black object with the black baton. According to another exemplary embodiment, as shown in FIGS. 11a and 11b, of one or both of the batons may change size (e.g., length) during gameplay so that a player must first notice that one or both of their batons is suddenly longer, or shorter, and then must compensate for the change in baton length as they coordinate their swing movements for a proper hit. As shown in FIGS. 11a and 11b, a black left baton 1002 is at a first length. A white right baton 1104a is also at a first length. When the baton change is made, the black left baton 1102 remains the same length—unchanged, while the white right baton 1104a is shortened to a new shorter length 1104b, as shown in FIG. 11b. The longer the baton is, the faster the tip of the baton will travel for a given swing speed, which corresponds to a more powerful hit being registered by the game system. So, although a longer baton may suddenly cause awkwardness and some misaligned swings, the player will enjoy a higher strength score for the objects they do manage to hit. In contrast, a shorter baton means a shorter reach for the player and less power in the swing. A shorter baton will force the player to reach out further with their body to successfully hit a passing object, and this will require more energy from the player, resulting in a harder workout. According to this embodiment, the player may either be warned that a baton-length change is imminent by flashing the illumination of the virtual batons, for example. The reason for a baton-length change may be random, just to increase gameplay challenge and overall surprise and interest, or may be triggered as a reward, in response to a player achieving a prescribed level of gameplay ability and challenges, such as successfully hitting 30 objects correctly in a row, or maintaining a certain level of average power during the game. In such instances, the baton length may increase. In contrast, a baton length may be shortened in response to poor gameplay or if it is determined by the system that the player is not moving around enough (by sensing the location of the player's headset). A shortened baton will force a player to reach more, and thereby move more. The baton length may change either instantly, or gradually.

### Batons Change Color

Also related to the batons, and according to another exemplary embodiment herein, one or both of the player's batons may exchange their colors at any time during gameplay to again, provide additional challenges to the player. During a color change, the player's left black baton becomes white, and the player's right white baton becomes black. This provides an immediate challenge to the player who must mentally reverse “muscle memory” that was established and set during earlier gameplay.

Continuing with another exemplary embodiment, the batons (i.e., the virtual representation of the batons) may become bent, broken or otherwise damaged during gameplay, or even lost entirely, should a player exceed prescribed limits of baton usage, such as power, lack of power, or even hitting the batons together, or hitting the perimeter of passing triangles. For example, if a player hits too wildly and with too much speed and power, the baton may be programmed to bend or even break, for a prescribed period of time. The same may occur in response to a player swinging a baton too weakly.

Alternatively, to help encourage a player to provide sufficient power when hitting the objects, according to additional embodiments, the system may be programmed so that the objects only explode when they are hit with the baton with sufficient power and speed.

If not, the objects will simply become dented or bounce away undamaged. To ensure the satisfaction of an object being hit and exploding, the player must hit the object with sufficient speed and power.

### Objects Split and Change Transparency

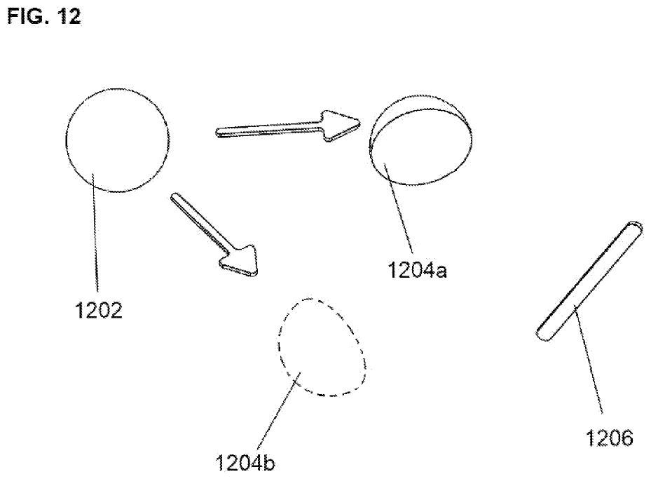

According to yet other exemplary embodiments, referring now to FIG. 12, an object 1202 that approaches a player (not shown) during gameplay may split apart at some point between the portal and the player, so that the player is suddenly challenged with having to hit two or more objects 1204a, 1204b (which may be the same size as the original object 1202, or different sized), instead of just one object 1202. Each breakaway piece 1204a, 1204b of the original object 1202 may all retain the same color as the original object, or change to another color for added challenge. The player must now use baton 1206 to hit the two objects 1204a, 1204b. When an object splits into multiple objects (e.g., into two objects), the resulting objects may be (but need not be) smaller than the original object.

Furthermore, select objects may fade a prescribed amount, from slightly transparent to completely invisible (0% opaque), prior to reaching the player. This is illustrated in FIG. 12 wherein object 1204b is made with dashed lines. The dashed lines represent any level of transparency of object 1204b. With this arrangement, the player is forced to rely on their memory skills to keep track of the transparent object as it reaches the hitting zone adjacent the player. The objects may follow a beat-map to select music. The player may use the beats of the music to help coordinate their swing to match the object for a successful hit.

According to yet another exemplary embodiment, objects that approach a player during gameplay may change speed and trajectory between the portal and the player. For example, some objects may follow a straight path between the portal and the player, while other objects may follow a parabolic (or some other curved) path, similar to the path that any thrown object follows due to gravity. This change in flight paths of select objects provides additional challenges to any player during gameplay.

### Animations

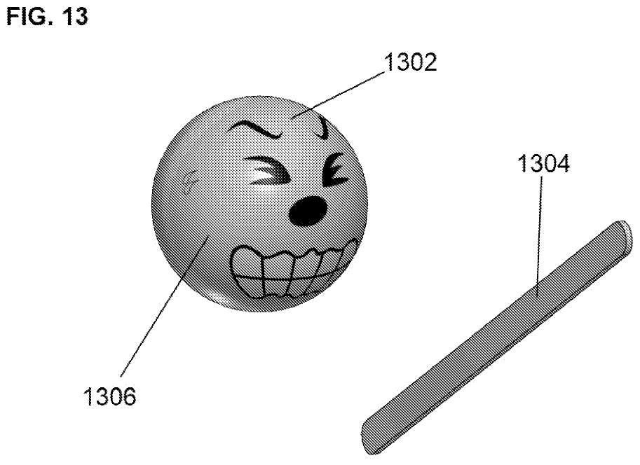

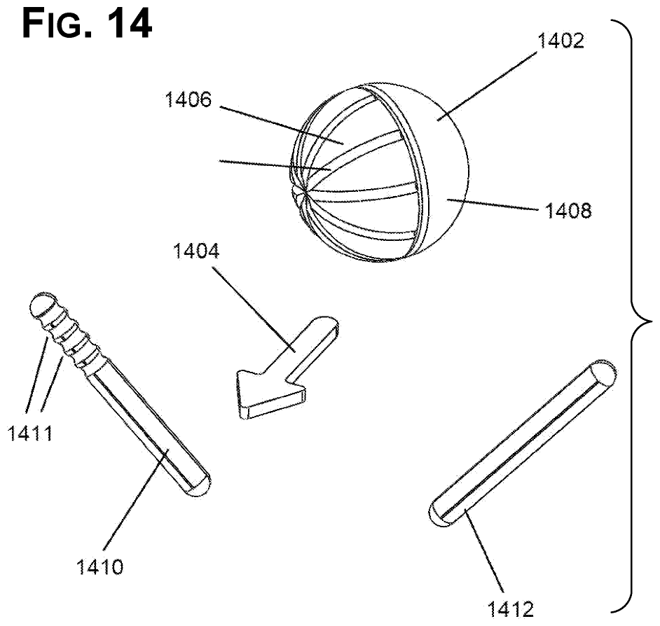

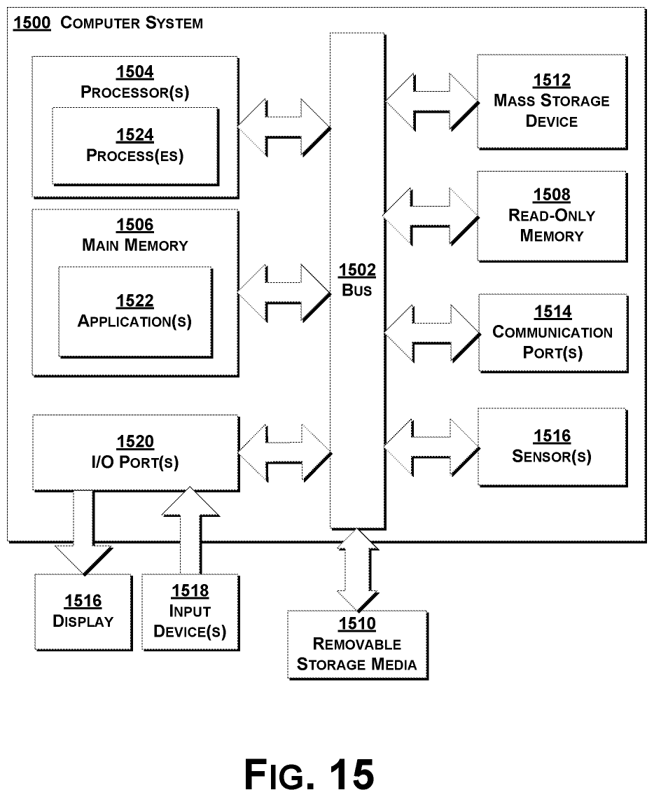

According to yet other exemplary embodiments, referring to FIG. 13, an object 1302 that approaches a player's baton 1304 during gameplay may change to include an image or an animation 1306 on its surface to help communicate playful emotion, such as an emoji-like appearance conveying a fear of being hit, or a showing of anger, defiance, or laughter. The type of emotion being conveyed by the object may be in response to how well the player is playing. For example, if a player is not hitting hard enough, the emoji will show laughter, as the object taunts the player to hit harder. This feature may be particularly useful to instruct children playing the game to better understand constructive feedback to change their future behavior at hitting objects. If a child is swinging too weak, for example, the objects may soon include a cartoon showing a scared expression, meaning that the object would be happy if the child swings harder and faster.

### Themes

According to yet other exemplary embodiments, objects, batons, environments, and other items used and seen during gameplay may be shaped, colored, or printed thereon following a common theme that aligns with events commonly occurring on calendar dates, such as Easter, or the Fourth of July. Objects would resemble eggs on Easter, and Christmas would change the batons into candy canes and the objects would resemble ornaments, for example. The themes may automatically generate based on the current date. This may include the player's birthday and other more personal events captured from the player's profile. Additionally, location data (e.g., GPS data) read by the system may generate themes within the VR gaming world that are based on the location of the player. For example, a theme within the VR game could be directed to a local sports team.

According to yet other exemplary embodiments, the present VR system projects specifically identifiable objects towards the player in such a manner that encourages the player to only hit the object when it actually passes the player, either on the player's left side, right side, or above them. According to these embodiments, these specifically identifiable objects would differentiate from other types of objects through unique markings, or unique illumination, or any other means that would allow a player to understand which objects are meant to be hit after passing the player.

For example, referring to FIG. 14, an object 1402 is shown moving along a path indicated by arrow 1404. The object 1402, in this example, includes two parts (e.g., halves, 1406 and 1408), each of which is differentiated from the other by color or pattern, design, shape, or some other distinction so that the player can identify the two halves 1406, 1408. In the example shown in FIG. 14, a front half 1406 includes a lined pattern 1407 to represent the color black. The lines or black color difference allow the player to distinguish the front half 1406 from the rear half 1408 of the object 1402.

A player (not shown in the figure) is holding a left controller and a right controller in the real world, which is translated in the virtual world as a black baton 1410 for the left controller and a white baton 1412 for the right controller. The black baton 1410 in FIG. 14 includes lines 1411 to represent the black color. During gameplay, and as understood from the description of earlier embodiments, the player may independently swing the batons at the projected objects, using the black baton for black-colored objects and the white baton for white-colored objects.

According to this embodiment, and the rules of the game for this particular embodiment, the player would encounter a mix of objects, some colored completely black, some completely white, and other objects with mixed colors, black and white (or, as described above, objects with distinctive and different halves). As before, for solid colors, the player would hit the object 1402 with the corresponding colored baton when the object 1402 reached a point in front of the player (not shown). For mixed-colored objects, such as object 1402, shown in FIG. 14, the player would have an option to hit either colored region of the mixed-colored object with the appropriate baton. In the example shown in FIG. 14, the player may hit the front black portion 1406 as the object 1402 approaches the player, using the black baton 1410 or, for additional points and a harder workout, the player may use the white baton 1412 to hit the white portion 1408 of the object. The challenge here is that the player would have to wait for the object to pass before the otherwise hidden white portion is accessible to be hit. This means that the player would have to rotate their body on the side the object passes to be able to hit the white portion 1408 of the object 1402 after the object passes by. Although this feature would certainly provide additional challenges in standard gameplay, having a player twist at the waist to be able to hit the backside of a passing object would provide substantial benefits as a workout feature. The twisting action would help work the player's core and strengthen various abdominal muscle groups.

According to this one embodiment, the player may be given a choice to either hit either half 1406 or 1408 as the object approaches or may be instructed to hit one or the other half by the computer at a predetermined time before the object reaches the player in the virtual world. Such instruction may include illuminating one of the two batons to indicate to the player which half of the object 1402 should hit.

Also, according to another aspect of this one embodiment of the invention, the object 1402 may be instructed to rotate with respect to the player (in any manner, about any axis), thereby making it more challenging for the player to hit either half of the object 1402 when the object reaches the player.

Although the term “half” (and “halves”) are used in the previous description, this is done by way of example, those of skill in the art will understand, upon reading this description, the object 1402 may split other than in parts other than equal halves. Similarly, those of skill in the art will understand, upon reading this description, that colors other than black and white may be used to distinguish the parts of the object and the batons with which those parts should be hit.

According to yet other exemplary embodiments, the objects may be projected toward the player and the player may try to hit them based on their color and the direction indicator. If the player is successful, the object may be shown bursting apart with a sound and a flash of light. If the player misses, the object may simply continue along its trajectory, passing the player, and then disappearing, no longer to reappear again. According to these embodiments, missed objects may be recycled back into play so that the session will end when all the starting objects have been successfully hit, however long it takes. The music track being played may just continue as a remix until all the objects are eventually hit. Alternatively, new music tracks can be played. Any recycled object can either be identical to the other objects, or identified with a different color, or blinking, or wobbling, or other. The recycled objects may reenter the game smaller in size than the original, to offer more of a challenge to the player.

According to yet other exemplary embodiments, the objects may be projected towards the player from the portal and either successfully hit by the player, or missed. If an object is successfully hit by a baton, instead of bursting apart, as before, the object may project away following a specific new trajectory, depending on the angle and magnitude of impact by the baton. The object may then either impact a distant spot within the virtual environment, with a realistic or otherwise dramatic explosion, or it may ricochet along a new trajectory to a new impact spot in the environment, again and again. This feature may result in hundreds of objects flying around the player within the environment, providing challenges to the player as they struggle to concentrate hitting newly projected objects.

According to yet other exemplary embodiments, at some point during the game session, a plurality of objects fly towards the player at once or sequentially in very fast succession, surprising the player with a kind of bonus opportunity to hit many objects as quickly as possible.

According to yet other exemplary embodiments, a uniquely identified object, when successfully hit, may offer the player a reward of a respite from projected objects for a predetermined period of time. This allows the player to relax and recharge for more intense gameplay, or a chance to just briefly dance along with the music.

According to yet other exemplary embodiments, the player may be able to change an aspect of gameplay simply by tapping the virtual batons against each other in the virtual world. For example, the action may change the song being played, or perhaps a particular mode of the gameplay, such as the speed of objects being projected, or switching to a mode with no lunge triangles, or change the type of handheld gaming implement from a baton, for example, to a boxing glove, and so on. In the latter example, both objects meant to be hit with batons and objects meant to be punched can be projected towards a player. The different types of objects may be identified and, following the rules of the game, and these embodiments, the player may have to switch between batons and boxing gloves, depending on the type of object next to be hit. The player would make the switch by tapping either the virtual batons or virtual boxing gloves against each other in the virtual world.

Although different embodiments are described herein, those of skill in the art will understand, upon reading this description, that the various embodiments may be combined and/or mixed, and that such combination and/or mixing is contemplated herein. Thus, a particular system may include some or all of the above-described embodiments, alone or in various combinations. For example, and without limitation, a particular implementation may include aspects of one or more of:
Conveying Information to the Player Using Virtual Objects and Shapes (e.g., triangles);
Add Hit Segments to the Triangles;
Batons Change Size;
Batons Change Color;
Objects Split and Change Transparency;
Animations; and/or
Themes

### Real Time

Those of ordinary skill in the art will realize and understand, upon reading this description, that, as used herein, the term “real time” means near real time or sufficiently real time. It should be appreciated that there are inherent delays in electronic components and in network-based communication (e.g., based on network traffic and distances), and these delays may cause delays in data reaching various components. Inherent delays in the system do not change the real time nature of the data. In some cases, the term “real time data” may refer to data obtained in sufficient time to make the data useful for its intended purpose.

Although the term “real time” may be used here, it should be appreciated that the system is not limited by this term or by how much time is actually taken. In some cases, real-time computation may refer to an online computation, i.e., a computation that produces its answer(s) as data arrives, and generally keeps up with continuously arriving data. The term “online” computation is compared to an “offline” or “batch” computation.

In some cases, in the context of a Virtual Reality (VR), Mixed Reality (MR), or Augmented Reality (AR) system, the term “real-time” may mean sufficient time to allow a user's interactions and/or movements with the system to be reflected in the system in a manner that appears or is perceived to be immediate and without perceptible lag.

### Computing

The applications, services, mechanisms, operations, and acts shown and described above are implemented, at least in part, by software running on one or more computers.

Programs that implement such methods (as well as other types of data) may be stored and transmitted using a variety of media (e.g., computer-readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general-purpose computers, special-purpose computers and computing devices. One or more such computers or computing devices may be referred to as a computer system.

FIG. 15 is a schematic diagram of a computer system 1500 upon which embodiments of the present disclosure may be implemented and carried out.

According to the present example, the computer system 1500 includes a bus 1502 (i.e., interconnect), one or more processors 1504, a main memory 1506, read-only memory 1508, removable storage media 1510, mass storage 1512, and one or more communications ports 1514. Communication port(s) 1514 may be connected to one or more networks (not shown) by way of which the computer system 1500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 1504 can be any known processor, such as, but not limited to, an Intel® Itanium® or Itanium 2® processor(s), AMD® Opteron® or Athlon MP® processor(s), or Motorola® lines of processors, and the like. Communications port(s) 1514 can be any of an Ethernet port, a Gigabit port using copper or fiber, or a USB port, and the like. Communications port(s) 1514 may be chosen depending on a network such as a Local Area Network (LAN), a Wide Area Network (WAN), or any network to which the computer system 1500 connects. The computer system 1500 may be in communication with peripheral devices (e.g., display screen 1516, input device(s) 1518) via Input/Output (I/O) port 1520.

Main memory 1506 can be Random Access Memory (RAM), or any other dynamic storage device(s) commonly known in the art. Read-only memory (ROM) 1508 can be any static storage device(s), such as Programmable Read-Only Memory (PROM) chips for storing static information such as instructions for processor(s) 1504. Mass storage 1512 can be used to store information and instructions. For example, hard disk drives, an optical disc, an array of disks such as Redundant Array of Independent Disks (RAID), or any other mass storage devices may be used.

Bus 1502 communicatively couples processor(s) 1504 with the other memory, storage, and communications blocks. Bus 1502 can be a PCI/PCI-X, SCSI, a Universal Serial Bus (USB) based system bus (or other) depending on the storage devices used, and the like. Removable storage media 1510 can be any kind of external storage, including hard-drives, floppy drives, USB drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random-access memory, which typically constitutes the main memory of the computer. Transmission media include coaxial cables, copper wire and fiber optics, including the wires that comprise a system bus coupled to the processor. Transmission media may include or convey acoustic waves, light waves, and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer-readable media may be involved in carrying data (e.g., sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements which are appropriate to perform the methods.

As shown, main memory 1506 is encoded with application(s) 1522 that support(s) the functionality as discussed herein (the application(s) 1522 may be an application(s) that provides some or all of the functionality of the services/mechanisms described herein, e.g., VR sharing application 230, FIG. 2). Application(s) 1522 (and/or other resources as described herein) can be embodied as software code such as data and/or logic instructions (e.g., code stored in the memory or on another computer-readable medium such as a disk) that supports processing functionality according to different embodiments described herein.

During operation of one embodiment, processor(s) 1504 accesses main memory 1506 via the use of bus 1502 in order to launch, run, execute, interpret, or otherwise perform the logic instructions of the application(s) 1522. Execution of application(s) 1522 produces processing functionality of the service related to the application(s). In other words, the process(es) 1524 represent one or more portions of the application(s) 1522 performing within or upon the processor(s) 1504 in the computer system 1500.

For example, process(es) 1524 may include an AR application process corresponding to VR sharing application 230.

It should be noted that, in addition to the process(es) 1524 that carries (carry) out operations as discussed herein, other exemplary embodiments herein include the application(s) 1522 itself (i.e., the un-executed or non-performing logic instructions and/or data). The application(s) 1522 may be stored on a computer-readable medium (e.g., a repository) such as a disk or in an optical medium. According to other exemplary embodiments, the application(s) 1522 can also be stored in a memory type system such as in firmware, read-only memory (ROM), or, as in this example, as executable code within the main memory 1506 (e.g., within Random Access Memory or RAM). For example, application(s) 1522 may also be stored in removable storage media 1510, read-only memory 1508, and/or mass storage device 1512.

Those skilled in the art will understand that the computer system 1500 can include other processes and/or software and hardware components, such as an operating system that controls allocation and use of hardware resources.

As discussed herein, embodiments of the present invention include various steps or acts or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware, or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another exemplary embodiment, the process includes some human intervention (e.g., a step is performed by or with the assistance of a human).

Although embodiments hereof are described using an integrated device (e.g., a smartphone), those of ordinary skill in the art will appreciate and understand, upon reading this description, that the approaches described herein may be used on any computing device that includes a display and at least one camera that can capture a real-time video image of a user.

For example, the system may be integrated into a heads-up display of a car or the like. In such cases, the rear camera may be omitted.

### Incorporation by Reference

Each of the following patent applications/publications is hereby fully incorporated herein by reference for all purposes and in its/their entirety:
1. U.S. patent application Ser. No. 17/236,543, filed Apr. 21, 2021, published as US 20210362029 A1, Nov. 25, 2021, titled “Virtual And Augmented Reality Personalized and Customized Fitness Training Activity or Game, Methods, Devices, and Systems.”
2. PCT/IB2021/053307, filed Apr. 21, 2021, published as WO/2021/214695 on Oct. 28, 2021.
3. PCT/US2022/046132, filed Oct. 8, 2022, titled “System to Determine a Real-Time User-Engagement State During Immersive Electronic Experiences.”

### Conclusion

As used herein, including in the claims, the phrase “at least some” means “one or more,” and includes the case of only one. Thus, e.g., the phrase “at least some ABCs” means “one or more ABCs,” and includes the case of only one ABC.

The term “at least one” should be understood as meaning “one or more,” and therefore includes both embodiments that include one or multiple components. Furthermore, dependent claims that refer to independent claims that describe features with “at least one” have the same meaning, both when the feature is referred to as “the” and “the at least one.”

As used in this description, the term “portion” means some or all. So, for example, “A portion of X” may include some of “X” or all of “X.” In the context of a conversation, the term “portion” means some or all of the conversation.

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only,” the phrase “based on X” does not mean “based only on X.”

As used herein, including in the claims, the phrase “using” means “using at least,” and is not exclusive. Thus, e.g., the phrase “using X” means “using at least X.” Unless specifically stated by use of the word “only,” the phrase “using X” does not mean “using only X.”

As used herein, including in the claims, the phrase “corresponds to” means “corresponds in part to” or “corresponds, at least in part, to,” and is not exclusive. Thus, e.g., the phrase “corresponds to factor X” means “corresponds in part to factor X” or “corresponds, at least in part, to factor X.” Unless specifically stated by use of the word “only,” the phrase “corresponds to X” does not mean “corresponds only to X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first” and “second” in the description and claims are used to distinguish or identify and not to show a serial or numerical limitation. Similarly, the use of letter or numerical labels (such as “(a),” “(b),” and the like) are used to help distinguish and/or identify and not to show any serial or numerical limitation or ordering.

No ordering is implied by any of the labeled boxes in any of the flow diagrams unless specifically shown and stated. When disconnected boxes are shown in a diagram, the activities associated with those boxes may be performed in any order, including fully or partially in parallel.

As used herein, including in the claims, singular forms of terms are to be construed as also including the plural form and vice versa unless the context indicates otherwise. Thus, it should be noted that as used herein, the singular forms “a,” “an,” and “the” include plural references unless the context clearly dictates otherwise.

Throughout the description and claims, the terms “comprise,” “including,” “having,” and “contain” and their variations should be understood as meaning “including but not limited to” and are not intended to exclude other components.

The present invention also covers the exact terms, features, values, and ranges, etc., in case these terms, features, values, and ranges, etc. are used in conjunction with terms such as about, around, generally, substantially, essentially, at least, etc. (i.e., “about 3” shall also cover exactly 3 or “substantially constant” shall also cover exactly constant).

Use of exemplary language, such as “for instance,” “such as,” “for example,” and the like, is merely intended to better illustrate the invention and does not indicate a limitation on the scope of the invention unless so claimed. Any steps described in the specification may be performed in any order or simultaneously, unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

Reference numerals have just been referred to for reasons of quicker understanding and are not intended to limit the scope of the present invention in any manner.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

1-17. (canceled)

18. A computer-implemented method for conveying information within a virtual environment, the method comprising:
determining a visual routine for a person to view in a virtual world using a device worn by the person in a real-world environment, the visual routine comprising a series of images representing projectiles, including triangles, wherein a triangle has a shape with a defined perimeter and an apex, the visual routine lasting a predetermined period of time;
presenting, based on the visual routine, a first triangle to the person in the virtual world; and
generating a virtual graphical mark at a prescribed location about the defined perimeter of the first triangle within the virtual world, the virtual graphical mark on the defined perimeter being visible to the person, a relative position of the virtual graphical mark with respect to the apex conveying information relating to an aspect of the visual routine.

19. The computer-implemented method of claim 18, wherein the virtual graphic mark comprises a gap within the defined perimeter of the first triangle.

20. The computer-implemented method of claim 18, wherein the aspect of the visual routine includes timing information related to the predetermined period of time.

21. The computer-implemented method of claim 18, wherein the aspect of the visual routine includes number of projectiles.

22. The computer-implemented method of claim 18, further comprising translating, based on a handheld controller, a real-hand location of the person's hand in the real-world environment to a corresponding virtual hand location in the virtual world.

23. The computer-implemented method of claim 22, further comprising providing a graphically generated and dynamically located handheld implement at the virtual hand location in the virtual world, wherein the handheld implement is viewable in the virtual world based on the person's real hand location in the real-world environment.

24. The computer-implemented method of claim 18, wherein determining the visual routine further comprises:
generating, at a graphically generated portal located in front of the person in the virtual world, at least one target, wherein the at least one target is designed to be hit by a handheld implement in the virtual world when the at least one target is located near the person in the virtual world;
projecting, from the portal, the at least one target towards the person in the virtual world; and
changing at least one aspect of the at least one target before the target reaches the person in the virtual world.

25. The computer-implemented method of claim 24, wherein changing the at least one aspect of the at least one target includes splitting the at least one target into two.

26. The computer-implemented method of claim 24, wherein changing the at least one aspect of the at least one target includes graphically changing the at least one target to appear transparent to the person.

27. The computer-implemented method of claim 24, wherein changing the at least one aspect of the at least one target includes graphically changing the at least one target to appear to be between 5% and 50% opaque to the person.

28. The computer-implemented method of claim 22, wherein changing the at least one aspect of the at least one target includes changing a projection speed of the at least one target as it approaches the person.

29. The computer-implemented method of claim 18, wherein the device comprises a virtual reality (VR) headset worn on a head of the person, the VR headset configured to provide images of scenes and objects to the person through the VR headset to generate a visual representation of a virtual world.

30. A headset device worn on a head of a person in a real-world environment, the headset device comprising:
one or more processors; and
a memory comprising instructions stored thereon, which when executed by the one or more processors, causes the one or more processors to:
determine a visual routine for a person to view in a virtual world, the visual routine comprising a series of images representing projectiles;
present, based on the visual routine, a target object to the person in the virtual world including a first indicator;
generate a graphical mark at a prescribed location about a defined perimeter of the target object within the virtual world, the virtual graphical mark being visible to the person, and a relative position of the virtual graphical mark indicating a hit direction for the target object;
translate a real-hand location of the person's hand in the real-world environment to a corresponding virtual hand location in the virtual world;
provide a handheld implement at the virtual hand location in the virtual world based on the handheld controller, wherein the handheld implement is viewable in the virtual world based on the real-hand location, the handheld implement includes a second indicator corresponding to the first indicator of the of the target object, and the handheld implement is designed to hit the target object in the virtual world when the target object is located near the person in the virtual world; and
change at least one aspect of the handheld implement before the target object reaches the person in the virtual world.

31. The headset device of claim 30, wherein the handheld implement is an elongated member.

32. The headset device of claim 30, wherein the instructions, when executed by the one or more processors, cause the one or more processors to:
generate the target object at a portal located in front of the person in the virtual world;
project, from the portal, the least one target towards the person in the virtual world; and
change at least one aspect of the target object before the target object reaches the person in the virtual world.

33. The headset device of claim 32, wherein the at least one aspect of the handheld implement includes a color of the handheld implement,

34. The headset device of claim 32, wherein the at least one aspect of the handheld implement includes a length of the handheld implement.

35. A non-transitory computer-readable storage media having computer-readable instructions stored thereon, the computer-readable instructions being executable by one or more processors to perform a method and cause the one or more processors to:
determine a visual routine for a person to view in a virtual world using a device worn by the person in a real-world environment, the visual routine comprising a series of images representing projectiles, including triangles, wherein a triangle has a shape with a defined perimeter and an apex, the visual routine lasting a predetermined period of time;
present, based on the visual routine, a first triangle to the person in the virtual world; and
generate a virtual graphical mark at a prescribed location about the defined perimeter of the first triangle within the virtual world, the virtual graphical mark on the defined perimeter being visible to the person, a relative position of the virtual graphical mark with respect to the apex conveying information relating to an aspect of the visual routine.

36. The non-transient computer-readable storage medium of claim 35, wherein the computer-readable instructions further cause the one or more processors to:
generate, at a graphically generated portal located in front of the person in the virtual world, at least one target, wherein the at least one target is designed to be hit by a handheld implement in the virtual world when the at least one target is located near the person in the virtual world, the handheld implement corresponding to a location of a handheld controller in the real-world environment;
project, from the portal, the least one target towards the person in the virtual world; and
change at least one aspect of the at least one target before the target reaches the person in the virtual world.

37. The non-transient computer-readable storage medium of claim 36, wherein changing the at least one aspect of the at least one target includes at least one of: (i) splitting the at least one target into two, (ii) graphically changing the at least one target to appear transparent to the person, (iii) graphically changing the at least one target to appear to be between 5% and 50% opaque to the person, and (iv) changing a projection speed of the at least one target as it approaches the person.
